(19) United States
(12) Patent Application Publication
(10) Pub. No.: US 2016/0377140 A1
(43) Pub. Date: Dec. 29, 2016

(54) BORING BARS AND METHODS OF MAKING THE SAME

(71) Applicant: Kennametal Inc., Latrobe, PA (US)

(72) Inventor: Ruy FROTA DE SOUZA FILHO, Latrobe, PA (US)

(21) Appl. No.: 14/751,929

(22) Filed: Jun. 26, 2015

(51) Int. Cl. F16F 7/108; B29C 45/14

(52) U.S. Cl. CPC F16F 7/108; B29C 45/14508; B29C 2045/14532; B29L 2009/00

(57) ABSTRACT

In one aspect, damping systems are described herein. Such damping systems can employ internal dynamic vibration absorbers. For example, a damping system described herein comprises a monolithic bar extending from a first end to a second end along a longitudinal axis. The monolithic bar comprises an enclosed cavity positioned therein. The damping system further comprises a dynamic vibration absorber disposed in the enclosed cavity. The dynamic vibration absorber includes an absorber mass and an elastomeric buffer arranged in spacing between one or more surfaces of the absorber mass and cavity wall.

### FIELD

The present invention relates to damping systems and, in particular, to damping systems employing an internal dynamic vibration absorber.

### BACKGROUND

Systems utilizing an elongated, cantilevered structure are generally subject to a degree of relative motion between a free end of the structure and a secured end. Frequently, repeated or oscillating relative motion of this type, referred to as vibration, may be problematic for a given system's intended function. For example, during a metalworking operation, motion of a free end of a boring bar relative to a secured end results in vibration or chatter. As a result of this vibration, a poor quality surface finish and/or an out-of-tolerance finished workpiece may be produced.

A variety of proposed solutions have been advanced in technologies utilizing cantilevered systems of the type described above. One method is to fabricate the cantilevered member from a stiffer material. However, stiffer materials can introduce additional cost or manufacturing lead time and may ultimately result in unacceptable levels of vibration. Additionally, many of the materials used in such solutions may be brittle or otherwise susceptible to accelerated wear. Passive dynamic absorbers are frequently used, however this solution requires assembly of multiple machined components and may impose additional cost. Additionally, such systems inevitably reduce stiffness, as the structural elements must be joined by threaded connections, bolts, press fittings, and the like. In light of the shortcomings of conventional systems, there exists a need to develop a simple damping system that provides maximum overall rigidity for the structure and methods of making the same.

### SUMMARY

In one aspect, damping systems are described herein. Such damping systems can employ internal dynamic vibration absorbers. For example, a damping system described herein comprises a monolithic bar extending from a first end to a second end along a longitudinal axis. The monolithic bar comprising an enclosed cavity positioned therein. The damping system further comprises a dynamic vibration absorber disposed in the enclosed cavity. The dynamic vibration absorber includes an absorber mass and an elastomeric buffer arranged in spacing between one or more surfaces of the absorber mass and cavity wall.

In another aspect, methods of fabricating a damping system are described herein. A method described herein can comprise forming by additive manufacturing a monolithic bar including an absorber mass disposed in an internal cavity of the monolithic bar. The method can further comprise injecting elastomeric material into spacing between the absorber mass and cavity wall via one or more conduits extending from the spacing to an outer surface of the monolithic bar.

These and other embodiments are described in further detail in the detailed description which follows.

### BRIEF DESCRIPTION OF THE DRAWINGS

FIGS. 1A-1C illustrate a damping system consistent with embodiments described herein at differing points of a formation or manufacturing process.

### DETAILED DESCRIPTION

Embodiments described herein can be understood more readily by reference to the following detailed description and examples and their previous and following descriptions. Elements and apparatus described herein, however, are not limited to the specific embodiments presented in the detailed description. It should be recognized that these embodiments are merely illustrative of the principles of the present invention. Numerous modifications and adaptations will be readily apparent to those of skill in the art without departing from the spirit and scope of the invention.

### I. Damping Systems

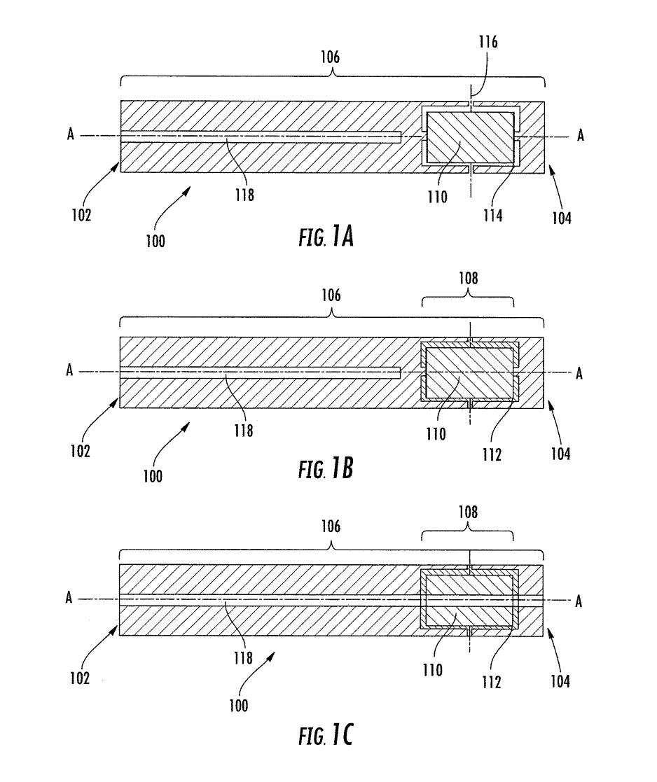

In one aspect, damping systems are described herein employing internal dynamic vibration absorbers. Referring now to FIGS. 1A-1C, there is illustrated a damping system, generally designated as reference 100, in accordance with one embodiment described herein. As provided in FIG. 1C, the damping system (100) comprises a monolithic bar (106) extending from a first end (102) to a second end (104) along a longitudinal axis (A-A). The monolithic bar (106) comprises an enclosed cavity positioned therein. The damping system (100) further comprises a dynamic vibration absorber (108) disposed within the enclosed cavity of the monolithic bar (106). The dynamic vibration absorber (108) includes an absorber mass (110) and an elastomeric buffer (112) arranged in spacing between one or more surfaces of the absorber mass (110) and cavity wall.

A damping system described herein can comprise or utilize any system including a monolithic body or bar. In certain embodiments, for example, a damping system consistent with the present disclosure can be used with a monolithic bar extending from a fixture or attachment point, as in the case of a cantilevered beam, rod, shaft or bar. One example of such a configuration is a boring bar or a tool holder. Boring bars can be utilized in internal and external turning, facing, grooving, and threading, among other operations. Boring bars or tool holders with excessive length-to-diameter ratios (typically above 4:1) may be prone to chatter or self-excited vibration when used in metal cutting operations. Other systems or applications are also possible. In some embodiments a damping system can be utilized in any application in which excessive deflection of a monolithic bar or cantilevered structure is possible and/or in circumstances in which vibration may be induced into such systems. In some cases, rotation of a monolithic bar or cantilevered structure can induce or facilitate propagation of such vibration.

As illustrated in FIG. 1C, damping systems (100) comprise a monolithic bar (106) extending from a first end (100) to a second end (104). Each of the first end (102) and the second end (104) can have any shape or architecture, or can be adapted or configured for any purpose or utility not inconsistent with the objectives of the present invention. For example, in some embodiments, the first end (102) is adapted to receive a tool (not shown). Any tool can be used. For example, a tool adapted or configured for use in drilling, cutting, or milling operations can be used. In some embodiments, the first end (102) comprises or includes a locking mechanism or similar operability which may secure or fasten the tool into position. In certain other embodiments, the first end (102) can comprise or include architecture which facilitates rapid interchangeability of a tool attached or fastened to the first end (102). In some embodiments, the second end (104) is adapted to engage a tool holder. Any tool holder can be used. For example, a tool holder can comprise or include a chuck, such as a collet chuck, or other architecture operable to receive an elongated structure, as in the case of a boring bar or rod. Such tool holders may comprise or include one or more components or parts adapted or configured to facilitate interchangeability of tools or boring bars having a variety of diameters and/or adapted or configured to facilitate expeditious replacement of a boring bar or tool.

Damping systems described herein comprise a monolithic bar (106) comprising an enclosed cavity positioned therein. An enclosed cavity can be surrounded, substantially surrounded, enclosed or substantially enclosed by an outer diameter of the monolithic bar. An outer diameter of the monolithic bar can surround, substantially surround, enclose or substantially enclose the cavity on all sides without interruption. A cavity can also be surrounded, substantially surrounded, enclosed or substantially enclosed by an outer diameter of the monolithic bar in embodiments wherein one or more conduits, ports, channels, or recesses are in communication with the internal cavity and an outer diameter of the monolithic bar. FIGS. 1A-1C illustrate such an embodiment in which the cavity is enclosed or substantially enclosed by the monolithic bar (106). In such configurations, any items, components, or elements disposed within the cavity would therefore be enclosed or substantially enclosed by the monolithic bar. An enclosed cavity defined by the monolithic bar can be positioned at any point within an internal portion of the monolithic bar. Additionally, an enclosed cavity can comprise or consist of any portion of an internal volume of the monolithic bar. A monolithic bar is integrally formed or otherwise formed of a single component. Such structure stands in contrast to an internal cavity which may be accessed by reversibly separable components, as in the case of a multi-component or multi-piece body or bar.

The monolithic bar is formed from a first material. The first material can comprise or include any material such as, for example, a metal, metal alloy, metal matrix composite, cermet, ceramic, cemented carbide and/or combinations thereof. The first material can be selected for suitability in the method of manufacture of the monolithic bar and/or the damping system. In some embodiments, the first material can be selected for suitability and/or utility in a desired application of the monolithic bar and/or damping system. For example, the first material can comprise or be formed from one or more materials suitable for manufacture of the monolithic bar by additive manufacturing techniques. Further discussion of methods of making damping systems are described further herein below in Section II.

Damping systems can further comprise a dynamic vibration absorber (108) disposed in the enclosed cavity. As illustrated in FIGS. 1A-1C, dynamic vibration absorbers (108) can comprise or include an absorber mass (110) and an elastomeric buffer (112). In some embodiments, the elastomeric buffer surrounds, substantially surrounds, encloses, or substantially encloses the absorber mass (110). Additionally, the elastomeric buffer (112) may only partially surround or partially enclose the absorber mass (110). The elastomeric buffer is arranged in spacing between one or more surface of the absorber mass and cavity wall as seen in FIG. 1B.

An absorber mass can have any shape. For example, in some embodiments, the absorber mass has the same or substantially the same cross-sectional shape as the monolithic bar. In certain other embodiments, the absorber mass has a shape which differs from the monolithic bar. The absorber mass can have a circular or rounded cross-sectional shape. In certain other cases, the absorber mass has a lobed, polygonal, or complex polygonal shape to follow an external shape of the bar, such as in the case of a milling cutter. Additionally, the absorber mass can be made of any material not inconsistent with the objectives of the present invention. In some embodiments, the monolithic bar comprises or is formed from a first material, and the absorber mass is formed from a second material. The first material and the second material, in some cases, are the same or substantially the same. In certain other cases, the first and second materials differ in at least one respect. For example, the second material can have a higher or greater mass density than the first material. In such embodiments, the absorber mass can have a tunable mass based on a selection of the material or materials included in the second material. In this manner, a vibrational frequency of the dynamic vibration absorber can be tuned to match or proximate one or more vibration modes of the monolithic bar. A “vibration frequency,” for reference purposes herein, indicates a vibration frequency along a dominant or primary vibration mode of the monolithic bar of the damping system. In some embodiments, a vibrational frequency of the dynamic vibration absorber is the same or substantially the same as vibrational frequency of the monolithic bar. Not intending to be bound by theory, the vibrational frequency of the dynamic vibration absorber may be tunable by modifying the size and/or mass of the absorber mass and the size, shape, and/or elasticity of the elastomeric buffer.

The absorber mass can be disposed at any point along a longitudinal axis of the monolithic bar. For example, in some embodiments, the absorber mass is disposed within the enclosed cavity such that the absorber mass is disposed proximate the first end or the second end. Such an embodiment is illustrated in FIG. 1C, wherein the absorber mass (110) is disposed within the monolithic bar (106) proximate the second end (104). In certain embodiments, the absorber mass is disposed equidistant to the first end and the second end. Further, the absorber mass can be disposed within the enclosed cavity such that a longitudinal axis is disposed relative to the longitudinal axis of the monolithic bar in any manner. In some embodiments, as illustrated in FIGS. 1B and 1C, the absorber mass (110) has a longitudinal axis collinear with a longitudinal axis (A-A) of the monolithic bar (106). In certain other embodiments, the longitudinal axis of the absorber mass is noncollinear with the longitudinal axis of the monolithic bar. In such embodiments, the absorber mass may have a longitudinal axis that is parallel to or, in other embodiments, oblique relative to the longitudinal axis of the monolithic bar.

In some embodiments, the second material forming the absorber mass is a single material such as a homogenous mass of a metal, metal alloy, metal matrix composite, cemented carbide, cermet, and/or combinations thereof. In certain other embodiments, the second material comprises or contains a mixture or gradient of differing materials. In this manner, a proportion of the total mass contained within the absorber mass may be tuned or altered to provide a desired configuration. For example, the absorber mass can comprise or be formed from a second material having a gradient of two or more materials such that a greater proportion of the mass contained within the absorber mass is disposed on one side, on a periphery, or in a core of the absorber mass. In certain other embodiments, the absorber mass may comprise or be formed from multiple materials disposed in discrete zones within the absorber mass.

The dynamic vibration absorber further comprises an elastomeric buffer. The elastomeric buffer can comprise or include any material demonstrating elasticity, a relatively low Young's modulus, and/or high failure strain and dampening. Non-limiting examples of materials usable in an elastomeric buffer can comprise or include one or more of a polyisoprene (natural or synthetic), a polybutadiene, chloropene rubber, a fluoroelastomer, a perfluoroelastomer, a polyether block amine, an ethylene-vinyl acetate, and a polyacrylic rubber. Other materials exhibiting elasticity may also be used. For example, a thermoplastic elastomer can be used such as a styrenic block copolymer, a polyolefin blend, an elastomeric alloy, a thermoplastic polyurethane, a thermoplastic copolyester and/or a thermoplastic polyamide. Such materials can be used, for example, in applications wherein it may be desired to form the elastomeric buffer by injection molding or similar processes. Further, as provided herein above, one or more materials forming the elastomeric buffer can be selected to impart desired vibrational frequency to the dynamic vibration absorber.

### II. Methods of Fabricating

In another aspect, methods are described herein. Methods described herein can comprise forming by additive manufacturing a monolithic bar. The monolithic bar includes an absorber mass disposed in an internal cavity of the monolithic bar. Methods further comprise injecting elastomeric material into spacing between the absorber mass and cavity wall via one or more conduits extending from the spacing to an outer surface of the monolithic bar.

Methods described herein comprise forming a monolithic bar by additive manufacturing. Any additive manufacturing process can be used. For example, one or more of extrusion, wire, granular, powder bed, lamination, and light polymerization based additive manufacturing can be used. Specific processes which may be usable in such methods can comprise or include one or more of fused deposition modeling (FDM), fused filament fabrication (FFF), robocasting, electron beam freeform fabrication (EBF), direct metal laser sintering (DMLS), electron-beam melting (EBM), selective laser melting (SLM), selective heat sintering (SHS), selective laser sintering (SLS), plaster-based 3D printing (PP), laminated object manufacturing (LOM), stereolithography (SLA), and/or digital light processing (DLP). Similarly, materials usable in such processes can comprise or include ceramics, metals, metal alloys, cermets, metal matrix composites, ceramic matrix composites, and/or thermoplastics. The monolithic bar can be formed from a first material and the absorber mass can be formed from a second material, and the first and second materials can individually comprise or be formed from any one or a combination of two or more of the above-identified materials. In some embodiments, as described in Section I, the first and second materials are the same or are substantially the same. In certain other embodiments, the first and second materials may differ. For example, the first material can be a steel and the second material can be a metal matrix composite, a solid metal, a different metal alloy, or a different grade or mixture of steel.

Damping systems formed by additive manufacturing consistent with methods described herein can have any shape or configuration not inconsistent with the above disclosure in Section I. For example, FIG. 1A illustrates a damping system which may be formed according to the present methods. FIG. 1A shows a damping system (100) comprising a monolithic bar (106) including an absorber mass (110) disposed in an internal cavity of the monolithic bar (106). The monolithic bar (106) extends from a first end (102) to a second end (104) along a longitudinal axis (A-A). At least one conduit (116) extends from the spacing of the enclosed cavity to an outer surface of the monolithic bar (106). As shown in FIG. 1A, the absorber mass (110) can be integral with or otherwise connected, fastened or attached to the monolithic bar (106) during or after formation of the damping system (100). In such embodiments, the absorber mass (110) can be detached or unfastened from the monolithic bar (106) prior to implementation or use of the damping system (100). In certain other embodiments, the absorber mass (110) may be formed or created without attachment to the monolithic bar (106). Further, the monolithic bar (106), as illustrated in FIG. 1A, can have a partial or complete coolant channel or fluid transport channel. In certain other embodiments, no such channel may exist at the time of formation of the damping system (100). In some cases, a coolant channel can be formed through the monolithic bar (106) and the absorber mass (110) during or after formation of the monolithic bar (106) by additive manufacturing. In the embodiments illustrated in FIGS. 1A-1C, a partial coolant channel is initially formed and is subsequently extended along the longitudinal axis (A-A) by drilling process for example, such that the absorber mass (110) is detached or disconnected from the monolithic bar (106) and is allowed to vibrate inside the bar to provide a damping effect.

Methods described herein further comprise injecting elastomeric material into the spacing between the absorber mass and cavity wall via one or more conduits extending from the spacing to an outer surface of the monolithic bar. Such process forms an elastomeric buffer. An elastomeric buffer can comprise or include any material consistent with the above disclosure of Section I herein. The elastomeric material and the absorber mass together form a dynamic vibration absorber. The dynamic vibration absorber can have any properties consistent with the above disclosure in Section I. For example, the dynamic vibration absorber can have a mass equal to or greater than a modal mass of the monolithic bar. Further, the dynamic vibration absorber can have a vibrational frequency the same or substantially the same as a vibrational frequency of the monolithic bar.

Formation of a monolithic bar by additive manufacturing followed by injection of an elastomeric material into the enclosed cavity can, in some embodiments, provide a monolithic bar which encloses or substantially encloses the absorber mass and/or the dynamic vibration absorber. Such structure can provide an integrally formed damping system without further assembly or disassembly.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A damping system comprising:
a monolithic bar extending from a first end to a second end along a longitudinal axis, the monolithic bar comprising an enclosed cavity positioned therein; and
a dynamic vibration absorber disposed in the enclosed cavity, the dynamic vibration absorber including an absorber mass and an elastomeric buffer arranged in spacing between one or more surfaces of the absorber mass and cavity wall.

2. The damping system of claim 1, wherein the monolithic bar is formed from a first material and the absorber mass is formed from a second material, the second material having a higher density than the first material.

3. The damping system of claim 1, wherein the monolithic bar is formed from a first material and the absorber mass is formed from a second material, the first and second materials being the same.

4. The damping system of claim 1, wherein a longitudinal axis of the absorber mass is collinear with the longitudinal axis of the monolithic bar.

5. The damping system of claim 1, wherein the monolithic bar defines an internal coolant channel.

6. The damping system of claim 5, wherein the internal coolant channel passes through the dynamic vibration absorber.

7. The damping system of claim 1, wherein a vibrational frequency of the dynamic vibration absorber is substantially the same as a vibrational frequency of the monolithic bar.

8. The damping system of claim 1, wherein a vibrational frequency of the dynamic vibration absorber is proximate a vibrational frequency of the monolithic bar.

9. The damping system of claim 1, wherein the first end of the monolithic bar is adapted to receive a tool; and wherein the second end of the monolithic bar is adapted to engage a tool holder.

10. A method of fabricating a damping system comprising:
forming by additive manufacturing a monolithic bar including an absorber mass disposed in an internal cavity of the monolithic bar; and
injecting elastomeric material into spacing between the absorber mass and cavity wall via one or more conduits extending from the spacing to an outer surface of the monolithic bar.

11. The method of claim 10, wherein the monolithic bar is formed from a first material and the absorber mass is formed from a second material, the second material having a greater density than the first material.

12. The method of claim 10, wherein the monolithic bar is formed from a first material and the absorber mass is formed from a second material, the second material and the first material being the same.

13. The method of claim 10 further comprising forming a coolant channel through the monolithic bar and the absorber mass.

14. The method of claim 10, wherein the absorber mass and the elastomeric material together form a dynamic vibration absorber; and
wherein a vibrational frequency of the dynamic vibration absorber is substantially the same as a vibrational frequency of the monolithic bar.

15. The method of claim 10, wherein the absorber mass and the elastomeric material together form a dynamic vibration absorber; and
wherein a vibrational frequency of the dynamic vibration absorber is proximate a vibrational frequency of the monolithic bar.

16. The method of claim 10, wherein a longitudinal axis of the absorber mass is collinear with a longitudinal axis of the monolithic bar.

17. The method of claim 10, wherein the first end of the monolithic bar is adapted to receive a tool and the second end of the monolithic bar is adapted engage a tool holder.
